(19) United States
(12) Patent Application Publication
(10) Pub. No.: US 2005/0083891 A1
(43) Pub. Date: Apr. 21, 2005

(54) Method and apparatus for updating frame number

(76) Inventor: Chia-En Chuang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/971,607

(22) Filed: Oct. 21, 2004

(30) Foreign Application Priority Data
Oct. 21, 2003 (TW) 92129098

(51) Int. Cl. H04B 7/216

(52) U.S. Cl. 370/335

(57) ABSTRACT

A method and system thereof for maintaining and broadcasting frame numbers in a digital communication system. The system monitors a frame number controller through a central controlling unit. The frame number controller maintains the frame numbers required by the system, as well as broadcasts the frame number for the subsequent data frame to each frame number receiver in the operational components. Each frame number receiver generates a frame boundary signal when a complete frame number is received from the frame number controller, and notifies the corresponding operational component to start using the frame number just received. The operational component can also determine if unfinished work according to the frame boundary signal exists, and report the error to the system. The aim is to provide a simple mechanism to maintain the synchronization of the system, and utilizes the serial port to transmit information related to the new frame number.

### BACKGROUND

The present invention relates to a frame number broadcasting scheme, and more particularly, to a method and apparatus thereof to maintain and broadcast a frame number through central management.

In a digital communication system, operational components often need to exchange real time information. The system usually appends a frame number to each data frame to maintain the synchronization between the operational components. Each operational component processes operations according to the frame number of the data frame to ensure that every operational component completes the expected operations within the transmission period of a data frame before passing the data frame to other operational components. In the digital communication system, some operational components are responsible for transmitting a data stream, while others are responsible for channel coding or decoding. The frame number currently used in every operational component of the system must be identical, and all the operational components must identify the beginning of a new data frame at the same time.

Accordingly, the digital communication system requires a dynamic mechanism for maintaining and redefining the frame number used in the operational components of the system. The mechanism is responsible for notifying the operational components to update the frame number. Furthermore the mechanism must precisely notify all the operational components of when to use the new frame number, so that all operational components may be synchronized by always using the same frame number. The operational component may also generate an error message to notify the system when unfinished work to be completed in the previous data frame exists. The system ensures that the real time information is processed correctly in all of the operational components if the system does not receive any error messages.

### SUMMARY

A method for maintaining and-broadcasting frame numbers in an existing digital system is provided. The digital system monitors a frame number controller through a central controlling unit to broadcast a new frame number of a next data frame to operational components, wherein each of the operational components has a corresponding frame number receiver. The frame number controller obtains the new frame number during a transmission period of a current data frame, and then broadcasts information related to the new frame number to the frame number receivers. Each operational component generates a frame boundary signal when the corresponding frame number receiver receives the new frame number from the frame number controller. The operational components then use the new frame number to process following operations. The frame boundary signal generated by each frame number receiver directs the corresponding operational component to determine if any unfinished work exists from the previous frame, if so the operational component may report to the central controlling unit.

The frame number controller determines the new frame number for the next data frame according to an update confirmation signal. The frame number controller receives the new frame number transmitted from the central controlling unit if the central controlling unit sends the update confirmation signal before a predetermined fixed period, otherwise the new frame number is acquired by increasing the frame number of the current data frame by one.

The predetermined fixed period is agreed to by both the central controlling unit and the frame number controller. The digital system uses a clock signal for timing and, frequency reference, and the predetermined fixed period is usually a multiple of a clock cycle to simplify the calculations. The predetermined fixed period must be shorter than the transmission period of a data frame.

Key features of the method and system for maintaining and broadcasting the frame number include transmitting the information related to the new frame number to each frame number receiver in serial. The frame number controller connects the frame number receiver using a serial port in practice. An advantage of using the serial port as an interface between the frame number controller and the frame number receivers is to reduce the number of cables, thus minimizing the hardware required. Additionally the serial port is much easy to arrange and implement.

The frame number controller sends information related to the new frame number to each frame number receiver, wherein the information comprises a frame number reset signal, a frame number data signal, and a frame number synchronous signal. The frame number reset signal is a notification to the frame number receivers to prepare for reception of the new frame number. The frame number data signal carries the new frame number bit by bit. The frame number synchronous signal is a reference clock signal for the frame number data signal, thus the frame number receivers are able to determine the duration of one bit in the frame number data signal. The frequency of the frame number synchronous signal is lower than the clock signal in the system,-and the period of the frame number synchronous signal is an integral multiple of the period of the clock signal. Each bit of the new frame number is transmitted at a lower frequency via the serial port. The bandwidth needed by each of these signals is only one bit per unit time, thus three single-bit transmission lines in the serial port are enough for implementation.

A system for maintaining and broadcasting frame numbers in an existing digital system is provided. The digital system monitors the frame number used in each operational component of the digital system through a central controlling unit. The system comprises a frame number controller connected to a plurality of frame number receivers in serial, wherein each frame number receiver is installed in a corresponding operational component. The frame number controller is controlled by the central controlling unit which determines a new frame number for a subsequent data frame, and broadcasts the information related to the new frame number to each of the operational components. The frame number controller obtains the new frame number by either receiving it from the central controlling unit or increasing the frame number of the current data frame during the transmission period of the current data frame. Each frame number receiver generates a frame boundary signal when receiving a complete new frame number and hence the corresponding operational component can start using the new frame number.

Each operational component determines the frame boundaries by counting the number of bits received in the frame number data signal, and generates the frame boundary signal indicating use of the new frame number. Thus the frame number controller does not need to connect extra lines to signal all the operational components to start using the new frame number. Better synchronization can thus be achieved as the frame boundary is identified by each operational component individually, so the latency delay can be minimized.

Another advantage is achieved by transmitting the new frame number to all operational components in the system by broadcasting. As a result, the central controlling unit only sends commands to the frame number controller, and is not requiring to perform any computation unless the frame number needs to be updated. The frame number controller has a counting mechanism which increases the current frame number by one if the central controlling unit does not send an update confirmation signal before a predetermined fixed period. The workload of the central controlling unit can be reduced, thus improving the performance of the system.

### DESCRIPTION OF THE DRAWINGS

The invention can be more fully understood by reading the subsequent detailed description in conjunction with the examples and references made to the accompanying drawings, wherein:

FIG. 1 is a simple block diagram showing an embodiment of the system for maintaining and broadcasting the frame number;

FIG. 2a˜FIG. 2d illustrate the status of various signals of the present embodiment when the frame number controller does not receive the command to update the frame number;

FIG. 3a˜FIG. 3d illustrate the status of various signals of the present embodiment when the frame number controller receives the command to update the frame number;

FIG. 4 is a flowchart showing the process performed by the frame number controller in an embodiment;

FIG. 5 is a flowchart showing the process performed by the frame number receiver in an embodiment.

### DETAILED DESCRIPTION

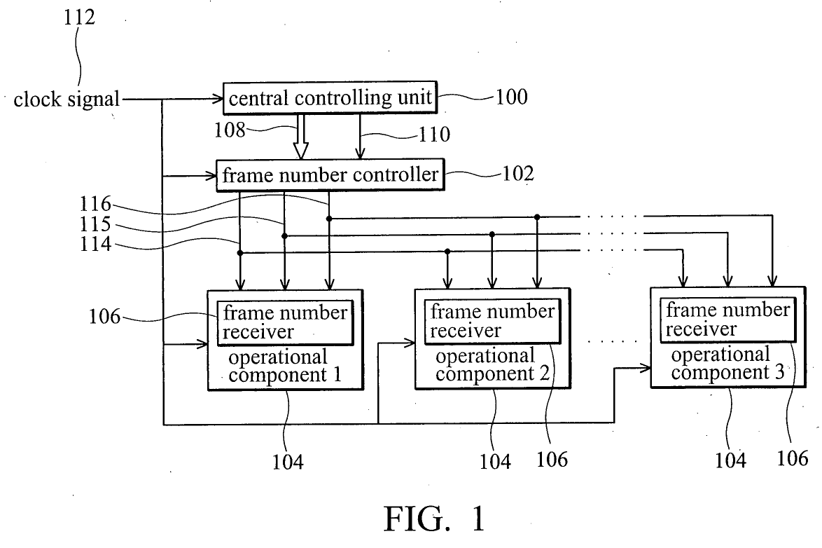

FIG. 1 is a simple block diagram illustrating an embodiment of a system for maintaining and broadcasting frame numbers. A frame number controller 102 receives an update confirmation signal 110 from a central controlling unit 100, and the frame number controller 102 determines a new frame number for a subsequent data frame according to the update confirmation signal 110. The frame number controller 102 receives a frame number 108 from the central controlling unit if the update confirmation signal 110 indicates “update valid”. The frame number controller 102 has a counting mechanism for the frame number, which adds one to the current frame number, producing a new frame number if the central controlling unit 100 has not performed the process of updating the frame number after a predetermined fixed number of clock signal periods, wherein the central controlling unit 100 performs the process of updating the frame number by sending an “update valid” command in the update confirmation signal 110 to the frame number controller 102. The frame number controller 102 is then responsible for broadcasting the new frame number to all frame number receivers 106 to maintain the synchronization by ensuring the same frame number is always used in every operational component. Each frame number receiver 106 is installed in a corresponding operational component 104.

The frame number controller 102 may connect each of the frame number receivers 106 using three single-bit transmission lines through a serial port. The signals transmitted on the three transmission lines are frame number reset signal 114, frame number synchronous signal 115, and frame number data signal 116. The frame number reset signal 114 indicates the beginning of the new frame number transmission. The frame number synchronous signal 115 has a lower frequency than the frequency of the clock signal 112, which serves as the reference clock signal for the frame number data signal 116. The frame number data signal 116 transmits the new frame number bit by bit. The frame number data signal 116 transmits one bit in every period of the frame number synchronous signal 115. The frame number receivers 106 determine the boundaries of the bits transmitted in the frame number data signal 116 according to the rising or falling edges of the frame number synchronous signal 115. The frame number receiver 106 can ignore the frame number synchronous signal 115 when receiving the frame number data if the timing of the receiver and the transmitter is already synchronized. The frame number synchronous signal 115 can be optionally used by the frame number receivers.

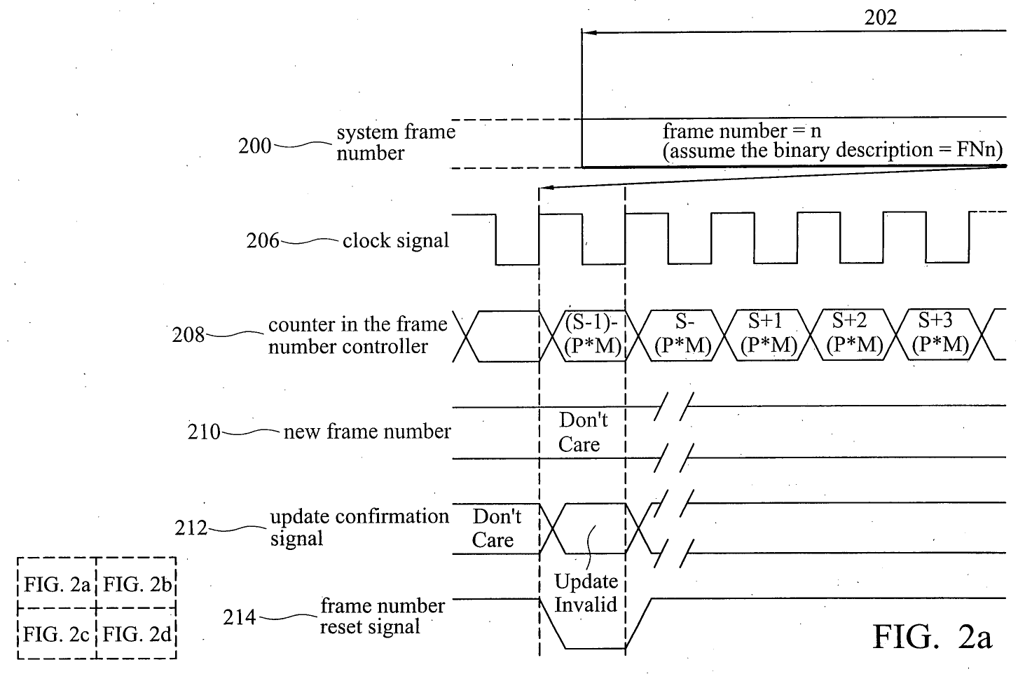

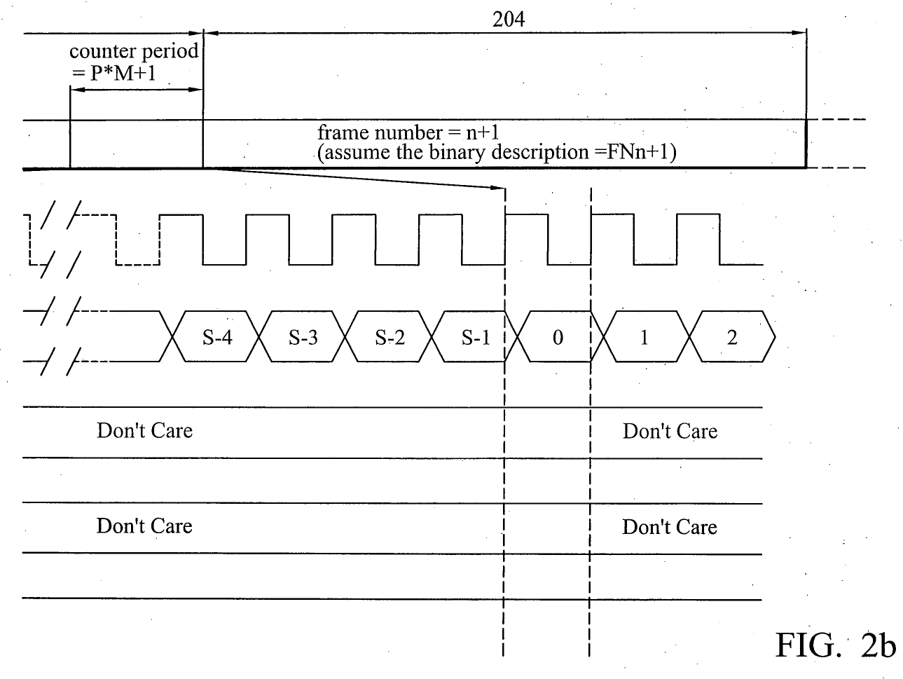

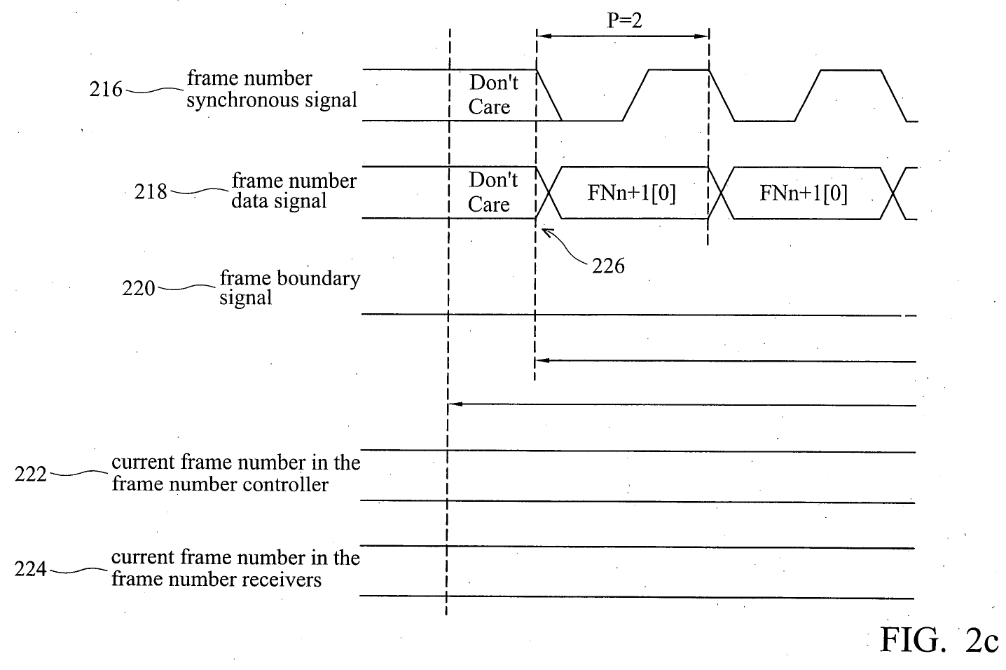

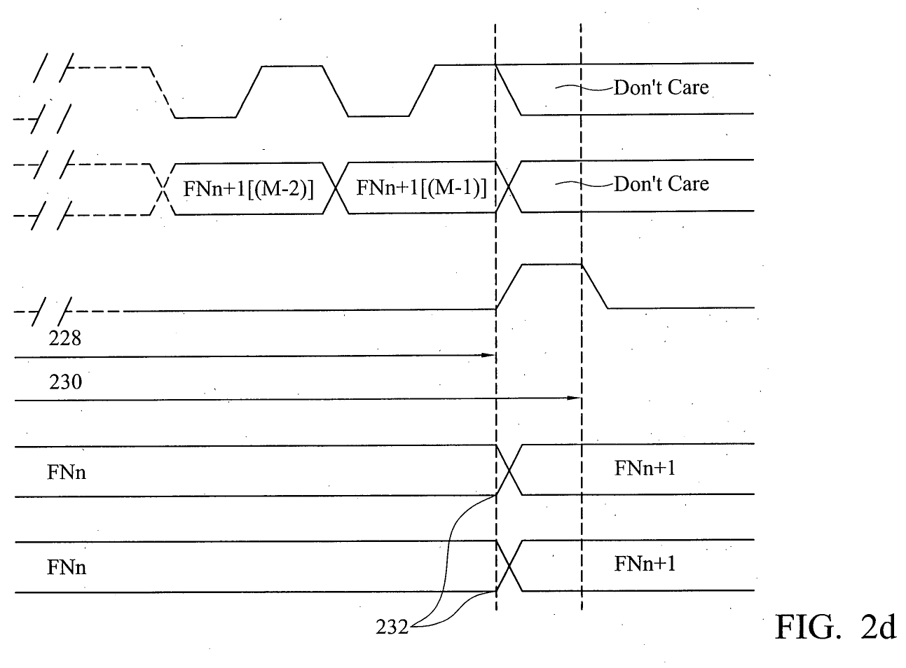

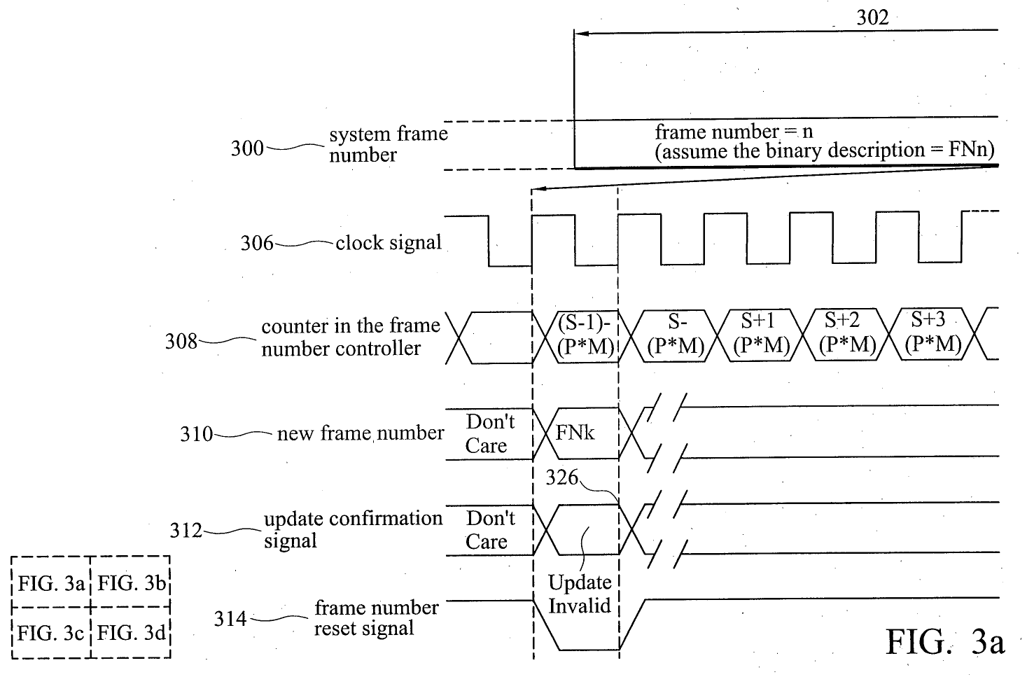

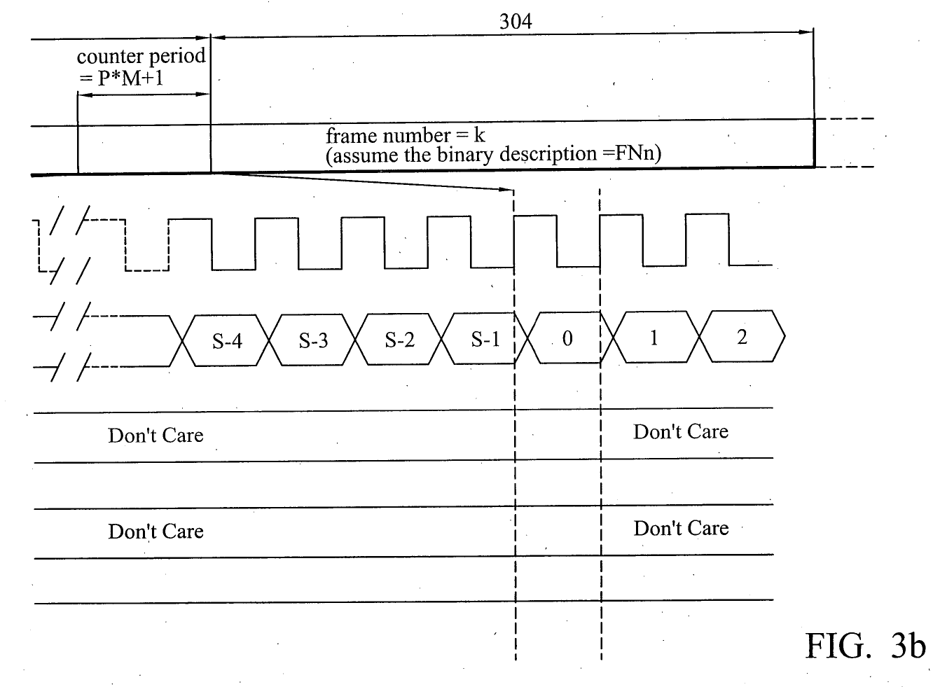

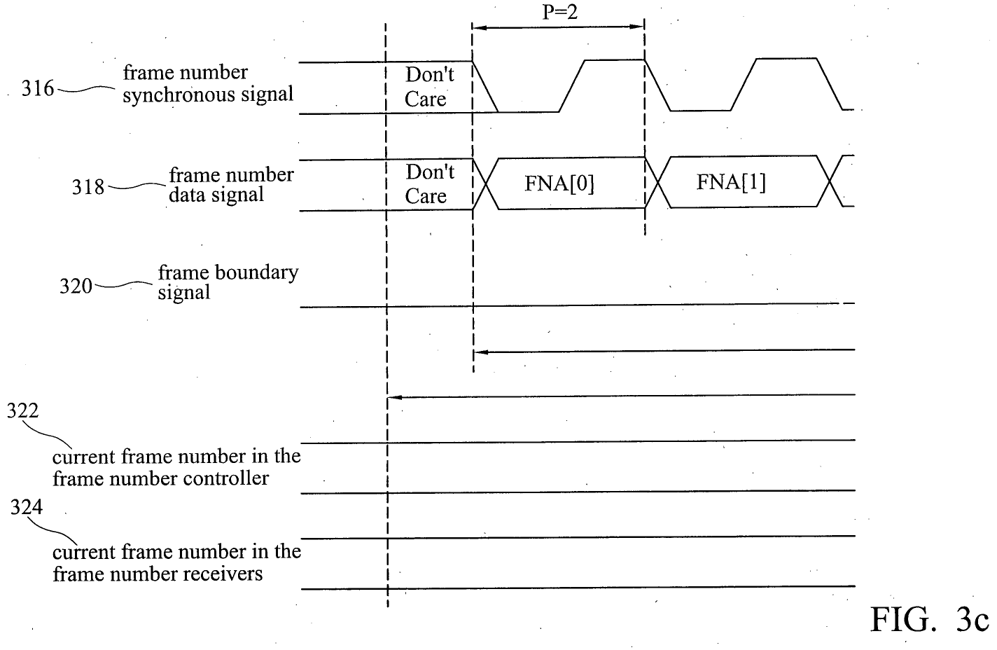

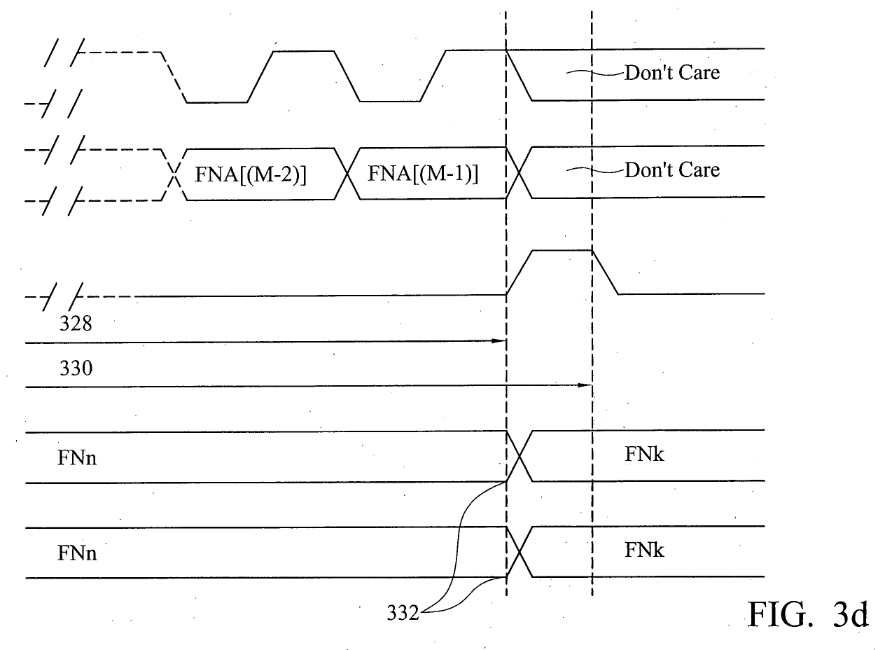

In accordance with FIG. 1, FIG. 2a˜FIG. 2d and FIG. 3a˜FIG. 3d illustrate two methods of obtaining the new frame number described in an embodiment. FIG. 2a˜FIG. 2d illustrate the status of various signals when the frame number controller 102 does not receive the command to update the frame number from the central controlling unit 100. The diagram shows the last portion of the transmission period of a data frame 202, wherein the system frame number (FN) of the data frame 202 is n (assumed the binary description is FNn). When an “update invalid” command is obtained from the signal status 212 of the update confirmation signal 110, the frame number controller 102 updates the frame number of the subsequent data frame 204 to be n+1 (binary description is FNn+1) as an increment of the current frame number of the data frame 202. In this case, the frame number controller 102 does not receive the new frame number 108 (signal status 210) from the central controlling unit 100.

The frame number controller 102 comprises a counter, and the signal status 208 of this counter counts the period of the clock signal 112 (signal status 206). The transmission period of a data frame is assumed to be S periods of the clock signal 112 in this example. The signal status 214 of the frame number reset signal 114 generates a reset signal at a predetermined fixed point 226 to notify the frame number receiver 106 to start receiving the new frame number. The fixed point 226 is defined as the signal status 208 of the counter is S−(P*M). It is assumed that each frame number is M bits, and the frame number data signal 116 (signal status 218) transmits one bit in every P clock signal periods. P is 2 in this example, representing the period of the frame number synchronous signal 115 (signal status 216) is equivalent to two periods of the clock signal 112 (signal status 206).

The frame number controller 102 transmits one bit of the new frame number (FNn+1) in every period of the frame number synchronous signal 115 (signal status 216) after the fixed point 226. Each frame number receiver 106 also comprises a counter for counting the number of bits received from the frame number controller 102. At point 232, the frame number receiver 106 generates a frame boundary signal (signal status 220) immediately after receiving the last bit of the new frame number. The frame boundary signal 220 indicates that a complete frame number has been received, as well as notifying the operational component 104 to update the frame number. The frame boundary signal 220 also provides reference timing for the operational component 104 if any operation is processed according to the timing of the new data frame.

The broadcasting period of the new frame number (period 228) starts from the fixed point 226 when the frame number controller 102 transmits the reset signal, until the beginning of the subsequent frame (point 232). The operating period 230 of the frame number controller 102 and the frame number receivers 106 is the time period 228, and further comprises a previous and a subsequent clock signal periods. The current frame number 222 of the frame number controller 102 is monitored by the central controlling unit 100. The frame number 222 of the frame number controller 102 should always be identical to the frame number 224 of the frame number receivers 106. Both the frame number controller 102 and the frame number receivers 106 should also update the new frame number at the same time (point 232 on the diagram) as the frame number receivers 106 generate the frame boundary signal (signal status 220).

FIG. 3a˜FIG. 3d are similar to FIG. 2a˜FIG. 2d, the difference is that in this case the frame number controller 102 receives an “update valid” command in the update confirmation signal 110 (signal status 312) before the fixed point 326. The central controlling unit 100 assigns the new frame number of the subsequent data frame to be k (binary description is FNk), so that the new frame number k is irrelevant to the current frame number n. The central controlling unit 100 sends this new frame number k to the frame number controller 102 before the fixed point 326. The new frame number FNk is transmitted with the frame number data signal 116 (signal status 218) bit by bit, and the last bit is received by the frame number receivers 106 at point 332. Since the new frame number FNk has been completely transmitted to the frame number receivers at point 332, both the frame number controller and the frame number receivers update the frame number from FNn to FNk.

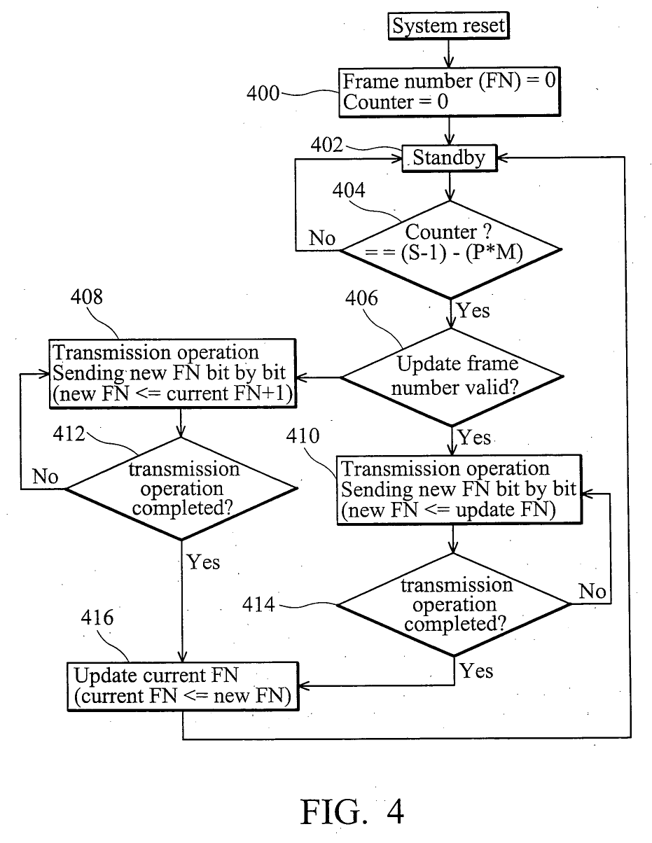

FIG. 4 is a flowchart illustrating the operations performed by the frame number controller in an embodiment. The frame number controller maintains the frame number by incrementing the current frame number after the predetermined fixed point in time, thus there is still a new frame number for the subsequent data frame regardless of the update information from the central controlling unit. The frame number used in the frame number controller is reset to zero in step 400, and the frame number controller is in the standby mode 402 until the counter is (S−1)-(P*M), which is a clock signal period before the predetermined fixed point 226 in FIG. 2. After satisfying the request in step 404, the frame number controller determines if the “update valid” command has been sent from the central controlling unit. The frame number controller processes step 410 if it receives the “update valid” command, otherwise step 408 is processed. The new frame number is received from the central controlling unit in step 410, and the new frame number is obtained by adding one to the current frame number as shown in step 408. The frame number controller transmits the new frame number bit by bit according to the frequency of the frame number synchronous signal, and the frame number controller examines if the transmission operation has been complete in step 412 and step 414. The frame number controller updates the current frame number to the new frame number immediately after the new frame number has been transmitted completely. The frame number controller then returns to the standby mode (step 402) and waits for the next frame number updating process.

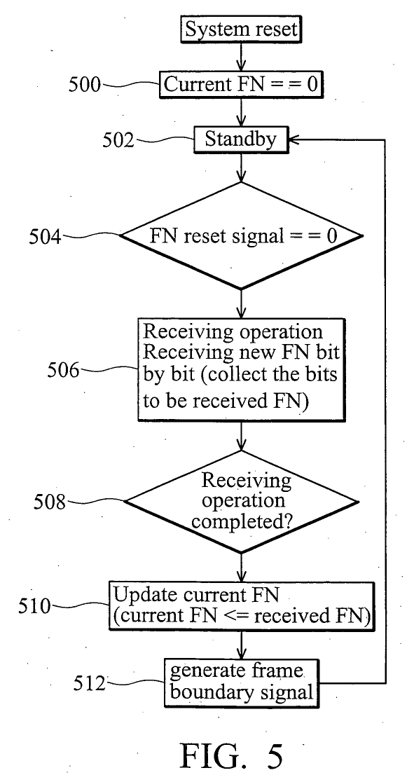

FIG. 5 is a flowchart illustrating the operations performed by the frame number receiver of an embodiment. The frame number of the frame number receiver is reset in step 500. The frame number receiver is in the standby mode (step 502) before receiving a reset command with the frame number reset signal. The frame number receiver starts to receive the new frame number bit by bit after receiving the reset command in step 506. The frame number receiver knows the total number of bits in the frame number, thus it detects if the new frame number has been received completely in step 508. The frame number receiver sets the current frame number to the new frame number in step 510, and immediately generates a frame boundary signal in step 512. The frame number receiver then returns to standby mode in step 502 until the next reset command is sent with the frame number reset signal.

Finally, while the invention has been described by way of example and in terms of the above, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for maintaining and broadcasting frame numbers in a digital system, the digital system monitoring a frame number controller through a central controlling unit to broadcast a new frame number of a next data frame, the method comprising the steps of:
the frame number controller obtaining the new frame number during a transmission period of a current data frame;
broadcasting information related to the new frame number to frame number receivers installed in operational components of the digital system; and
generating a frame boundary signal when each frame number receiver completely receives the new frame number, so the corresponding operational component can start using the new frame number.

2. The method according to claim 1, further comprising sending a clock signal to both the frame number controller and the frame number receivers as a reference for synchronization.

3. The method according to claim 1, wherein obtaining the new frame number further comprises:
receiving the new frame number transmitted from the central controlling unit after the frame number controller receives an update confirmation signal from the central controlling unit; and
acquiring the new frame number by increasing the frame number of the current data frame by one if the frame number controller has not received the update confirmation signal from the central controlling unit after a fixed period.

4. The method according to claim 3, wherein the fixed period is agreed by both the central controlling unit and the frame number controller, and is shorter than the transmission period of a data frame.

5. The method according to claim 1, wherein the frame number controller transmits the information related to the new frame number to the frame number receivers in serial.

6. The method according to claim 5, wherein the frame number controller transmits the information related to the new frame number to the frame number receivers through a serial port.

7. The method according to claim 1, wherein the information related to the new frame number comprises:
a frame number reset signal for reminding the frame number receivers to start receiving the new frame number; and
a frame number data signal carrying the new frame number bit by bit.

8. The method according to claim 7, wherein the information related to the new frame number further comprises a frame number synchronous signal for synchronizing the frame number data signal with the frame number receivers.

9. The method according to claim 8, wherein the frame number synchronous signal is a low frequency clock signal.

10. The method according to claim 1 further comprises each operational component:
examining if there is any incomplete work to be completed in the transmission period of the current data frame when the corresponding frame number receiver receives the frame boundary signal; and
sending a corresponding feedback signal for reporting a result to the central controlling unit.

11. A system for maintaining and broadcasting frame numbers in a digital system, comprising:
a central controlling unit for monitoring the frame numbers used in the digital system;
a frame number controller controlled by the central controlling unit, obtaining a new frame number corresponding to a next data frame during a transmission period of a current data frame, and broadcasting information related to the new frame number; and
a frame number receiver installed in each operational component of the digital system, for receiving the information related to the new frame number, and generating a frame boundary signal when the new frame number is completely received, so the corresponding operational component can start using the new frame number.

12. The system according to claim 11, further comprising sending a clock signal to both the frame number controller and the frame number receivers as a reference for synchronization.

13. The system according to claim 11, further comprising the frame number controller receiving the new frame number from the central controlling unit after receiving an update confirmation signal from the central controlling unit, else acquiring the new frame number by increasing the frame number of the,current data frame by one if the frame number controller has not received the update confirmation signal after a fixed period.

14. The system according to claim 13, wherein the fixed period is agreed to by both the central controlling unit and the frame number controller, and is shorter than the transmission period of a data frame.

15. The system according to claim 11, wherein the frame number controller transmits the information related to the new frame number to the frame number receivers in serial.

16. The system according to claim 15, wherein the frame number controller transmits the information related to the new frame number to the frame number receivers through a serial port.

17. The system according to claim 11, wherein the information related to the new frame number comprises:
a frame number reset signal for reminding the frame number receivers to start receiving the new frame number; and
a frame number data signal carrying the new frame number bit by bit.

18. The system according to claim 17, wherein the information related to the new frame number further comprises a frame number synchronous signal for synchronizing the frame number data signal with the frame number receivers.

19. The system according to claim 18, wherein the frame number synchronous signal is a low frequency clock signal.
